(19) United States
(12) Patent Application Publication
(10) Pub. No.: US 2023/0243399 A1
(43) Pub. Date: Aug. 3, 2023

(54) Shock Absorber Assembly and Method

(71) Applicant: N10Z Performance Shocks LLC, Johnson City, TN (US)

(72) Inventor: Peter Russell, Johnson City, TN (US)

(73) Assignee: N10Z Performance Shocks LLC, Johnson City, TN (US)

(21) Appl. No.: 18/102,319

(22) Filed: Jan. 27, 2023

Related U.S. Application Data
(60) Provisional application No. 63/304,194, filed on Jan. 28, 2022.

(51) Int. Cl. F16F 9/348; F16F 9/19

(52) U.S. Cl. CPC F16F 9/3488; F16F 9/19; F16F 2222/12; F16F 2232/08; F16F 2234/02; B60G 13/08

(57) ABSTRACT

A shock absorber is provided having a cylinder, a piston rod, a piston body, and a valve. The valve also includes a first valve seat formed at least in part by the piston body and a second valve seat formed at least in part by the piston body. The valve includes a first circumferential valving element configured to mate and demate with a first valve seat and a second circumferential valving element having a distal end portion, a proximal end portion, and a medial spring interposed between the distal end portion and the proximal end portion, the distal end portion configured to mate and demate with the second valve seat. A pair of pump pistons are also provided to provide feedback rebound forces to the first and second valving elements through springs. Engagement surfaces are also provided between the first and second valving elements. A method is also provided.

### CROSS REFERENCE TO RELATED APPLICATIONS

This patent application claims priority to and the benefit of U.S. Provisional Patent Application Ser. No. 63/304,194, filed Jan. 28, 2022; the entirety of which is incorporated by reference herein.

### TECHNICAL FIELD

This disclosure pertains to hydraulic or pneumatic shock absorbers and damping and/or shock mitigating valves and mechanisms for mitigation of shock transmission. More particularly, this disclosure relates to shock absorbers and damping and/or shock mitigating valves and control of shock absorber cavity pressures where impact force of a moving object is absorbed by causing a piston to displace hydraulic fluid from a cylinder through metering orifices, sprung bodies, fluid feedback loops and/or valves.

### BACKGROUND OF THE INVENTION

Shock absorbers and damping valves have been used on a number of vehicles including automobiles, trucks, motorcycles, and off-road vehicles to dampen shock transmission from a vehicle wheel to a frame or structure. Such shock absorbers and damping valves have also been used on industrial machines and processing equipment to dampen shock transmission between parts or subassemblies. They have also been used on any of a number of various operating mechanisms and machines, including weapons systems and mitigation systems for a pipe fluid shock transmission system. However, certain environments impart a broad range of high speed, large deformation, high speed, small deformation, low speed, large deformation, and low speed, small deformation. Presently used shock absorbers and valve assemblies fail to provide optimal performance across a full spectrum of such shock transmission conditions and further improvements are needed to provide higher order response characteristics and tunability in order to maximize performance, particularly for racing and competition conditions.

### SUMMARY OF THE INVENTION

A hydraulic shock absorber and auxiliary hydraulic fluid valve assemblies are provided for tuning and mitigating shock transmission over a broad range of impact speeds, forces, and volumetric fluid displacements for vehicles, machinery, and equipment.

According to one aspect, a shock absorber is provided having a cylinder, a piston rod, a piston body, and a valve. The cylinder is filled with a fluid. The piston rod reciprocates within the cylinder. The valve is carried by the piston body. The valve has at least one flow port through the piston body and communicating with a compression chamber end of the valve body. The valve also includes a first valve seat formed at least in part by the piston body and a second valve seat formed at least in part by the piston body. The valve further includes an annular valve chamber defined in part by the piston body and fluid coupled with the at least one flow port. The valve further includes a first circumferential valving element configured to mate and demate with the first valve seat at a proximal end and having a radially inward extending engagement flange on a proximal end. Additionally the valve includes a second circumferential valving element having a distal end portion, a proximal end portion, and a medial spring interposed between the distal end portion and the proximal end portion, the distal end portion configured to mate and demate with the second valve seat and engage with the proximal end of the first circumferential valving element when the first valving element demates with the first valve seat and the second valve element is mated with the second valve seat. Further, the valve includes a first valve spring configured to urge the first valving element in movable mating and demating relation against the first valve seat. The valve includes a second valve spring configured to urge the second valving element in movable mating and demating relation against the second valve seat, the first valve seat and the second valve seat each respectively demated from the first valve seat and the second valve seat responsive to fluid pressure in the annular valve chamber compressing the first spring and the second spring to provide a first fluid flow path and a second fluid flow path. Finally, the valve includes a housing including an auxiliary reservoir communicating with one of the compression chamber and the rebound chamber and a by-pass passage penetrating an inside of the piston rod in a longitudinal direction of the piston rod, the housing configured to form an auxiliary passage connected to one of the compression chamber and the rebound chamber.

### BRIEF DESCRIPTION OF THE DRAWINGS

Preferred embodiments of the disclosure are described below with reference to the following accompanying drawings.

FIG. 1 is an exploded and perspective vertical centerline sectional view of a mid-valve piston for a shock absorber taken along an axial centerline.

FIG. 2 is a compression end view of the mid-valve piston of FIG. 1.

FIG. 3 is a vertical centerline sectional view of the mid-valve piston taken along line 3-3 and showing one a pair of rebound ports.

FIG. 4 is a compression end view of the mid-valve piston of FIG. 1.

FIG. 5 is a compound sectional view of the mid-valve piston taken along line 5-5 and showing both a compression port and a rebound port.

FIG. 6 is a compression end view of the mid-valve piston of FIG. 1.

FIG. 7 is a compound sectional view of the mid-valve piston of FIGS. 1-6 showing both a compression port and the mid-valve piston is at a static state and a rebound port at a static state showing a rebound needle position adjustment change from that of FIG. 47 depicting the needle position in a more closed position than that of FIG. 47 and a rebound port at a later state than shown in FIG. 9 with fluid flow restriction allowing bypass where the outer conical piston is opening again in response to a threshold excessive force.

FIG. 8 is an enlarged sectional view of a mated inner valve seat and piston surface taken from encircled region 8 of FIG. 7.

FIG. 9 is an enlarged sectional view of a mated outer valve seat and piston surface taken from encircled region 9 of FIG. 7.

FIG. 10 is an enlarged sectional view of an outer valving element outer end stop taken from encircled region 10 of FIG. 7.

FIG. 11 is an enlarged sectional view of opposed conical springs taken from encircled region 11 of FIG. 7.

FIG. 12 is an enlarged sectional view of an outer valving element inner end stop taken from encircled region 12 of FIG. 7.

FIG. 13 is an enlarged sectional view of an open rebound needle taken from encircled region 13 of FIG. 7.

FIG. 14 is a compression end view of the mid-valve piston of FIG. 1.

FIG. 15 is a compound sectional view of the mid-valve piston of FIGS. 1-14 showing both a compression port and a rebound port at a later state than shown in FIG. 7 with more fluid flow at a later point in time.

FIG. 16 is an enlarged sectional view of a mated inner valve seat and piston surface taken from encircled region 16 of FIG. 15.

FIG. 17 is an enlarged sectional view of a mated outer valve seat and piston surface taken from encircled region 17 of FIG. 15.

FIG. 18 is an enlarged sectional view of an outer valving element outer end stop taken from encircled region 18 of FIG. 15.

FIG. 19 is an enlarged sectional view of opposed conical springs taken from encircled region 19 of FIG. 15.

FIG. 20 is an enlarged sectional view of an outer valving element inner end stop taken from encircled region 20 of FIG. 15.

FIG. 21 is an enlarged sectional view of an open rebound needle taken from encircled region 21 of FIG. 15.

FIG. 22 is a compression end view of the mid-valve piston of FIG. 1.

FIG. 23 is a compound sectional view of the mid-valve piston of FIGS. 1-22 showing both a compression port and a rebound port at a later state than shown in FIG. 15 with yet even more fluid flow and the initiation of pump piston movement to initiate shutting of the outer conical piston.

FIG. 24 is an enlarged sectional view of a mated inner valve seat and piston surface taken from encircled region 24 of FIG. 23.

FIG. 25 is an enlarged sectional view of a mated outer valve seat and piston surface taken from encircled region 25 of FIG. 23.

FIG. 26 is an enlarged sectional view of an outer valving element outer end stop taken from encircled region 26 of FIG. 23.

FIG. 27 is an enlarged sectional view of opposed conical springs taken from encircled region 27 of FIG. 23.

FIG. 28 is an enlarged sectional view of an outer valving element inner end stop taken from encircled region 28 of FIG. 23.

FIG. 29 is an enlarged sectional view of an open rebound needle taken from encircled region 29 of FIG. 23.

FIG. 30 is a compression end view of the mid-valve piston of FIG. 1.

FIG. 31 is a compound sectional view of the mid-valve piston of FIGS. 1-30 showing both a compression port and a rebound port at a later state than shown in FIG. 23 with fluid flow restriction where the outer conical piston is closed.

FIG. 32 is an enlarged sectional view of a mated inner valve seat and piston surface taken from encircled region 32 of FIG. 31.

FIG. 33 is an enlarged sectional view of a mated outer valve seat and piston surface taken from encircled region 33 of FIG. 31.

FIG. 34 is an enlarged sectional view of an outer valving element outer end stop taken from encircled region 34 of FIG. 31.

FIG. 35 is an enlarged sectional view of opposed conical springs taken from encircled region 35 of FIG. 31.

FIG. 36 is an enlarged sectional view of an outer valving element inner end stop taken from encircled region 36 of FIG. 31.

FIG. 37 is an enlarged sectional view of an open rebound needle taken from encircled region 37 of FIG. 31.

FIG. 38 is a compression end view of the mid-valve piston of FIG. 1.

FIG. 39 is a compound sectional view of the mid-valve piston of FIGS. 1-38 showing both a compression port and a rebound port at a later state than shown in FIG. 31 with fluid flow restriction allowing bypass where the outer conical piston body is opening again in response to a threshold excessive force.

FIG. 40 is an enlarged sectional view of a mated inner valve seat and piston surface taken from encircled region 40 of FIG. 39.

FIG. 41 is an enlarged sectional view of a mated outer valve seat and piston surface taken from encircled region 41 of FIG. 39.

FIG. 42 is an enlarged sectional view of an outer valving element outer end stop taken from encircled region 42 of FIG. 39.

FIG. 43 is an enlarged sectional view of opposed conical springs taken from encircled region 43 of FIG. 39.

FIG. 44 is an enlarged sectional view of an outer valving element inner end stop taken from encircled region 44 of FIG. 39.

FIG. 45 is an enlarged sectional view of an open rebound needle taken from encircled region 145 of FIG. 39.

FIG. 46 is a compression end view of the mid-valve piston of FIG. 1.

FIG. 47 is a compound sectional view of the mid-valve piston of FIGS. 1-46 showing both a compression port and a rebound port at a later state than shown in FIG. 39 with a perspective in a rebound fluid flow direction causing the rebound flapper valve stack to an open flow position in response to a rebound stroke.

FIG. 48 is an enlarged sectional view of a mated inner valve seat and piston surface taken from encircled region 48 of FIG. 47.

FIG. 49 is an enlarged sectional view of a mated outer valve seat and piston surface taken from encircled region 49 of FIG. 47.

FIG. 50 is an enlarged sectional view of an outer valving element outer end stop taken from encircled region 50 of FIG. 47.

FIG. 51 is an enlarged sectional view of opposed conical springs taken from encircled region 51 of FIG. 47.

FIG. 52 is an enlarged sectional view of an outer valving element inner end stop taken from encircled region 52 of FIG. 47.

FIG. 53 is an enlarged sectional view of an open rebound needle taken from encircled region 53 of FIG. 47.

FIG. 54 is a compression end view of the mid-valve piston of FIG. 1.

FIG. 55 is a compound sectional view of the mid-valve piston of FIGS. 1-54 showing both a compression port and the mid-valve piston is at a static state and a rebound port at a static state showing a rebound needle position adjustment change from that of FIG. 47 depicting the needle position in a more closed position than that of FIG. 47 and a rebound port at a later state than shown in FIG. 47 with fluid flow restriction allowing bypass where the outer conical piston is opening again in response to a threshold excessive force.

FIG. 56 is an enlarged sectional view of a mated inner valve seat and piston surface taken from encircled region 56 of FIG. 55.

FIG. 57 is an enlarged sectional view of a mated outer valve seat and piston surface taken from encircled region 57 of FIG. 55.

FIG. 58 is an enlarged sectional view of an outer valving element outer end stop taken from encircled region 58 of FIG. 55.

FIG. 59 is an enlarged sectional view of opposed conical springs taken from encircled region 59 of FIG. 55.

FIG. 60 is an enlarged sectional view of an outer valving element inner end stop taken from encircled region 60 of FIG. 55.

FIG. 61 an enlarged sectional view of an open rebound needle taken from encircled region 61 of FIG. 55.

FIG. 62 is a simplified partial component view showing the circumferential outer valving element, or outer circumferential cone piston and circumferential inner compound valving element, or inner circumferential compound cone piston.

FIG. 63 is a perspective view from above of an exemplary hydraulic shock absorber having a primary mid-valve piston assembly of FIGS. 1-62 and a secondary pair of adjustable auxiliary hydraulic fluid valves.

### DETAILED DESCRIPTION OF THE PREFERRED EMBODIMENTS

This disclosure is submitted in furtherance of the constitutional purposes of the U.S. Patent Laws “to promote the progress of science and useful arts” (Article 1, Section 8).

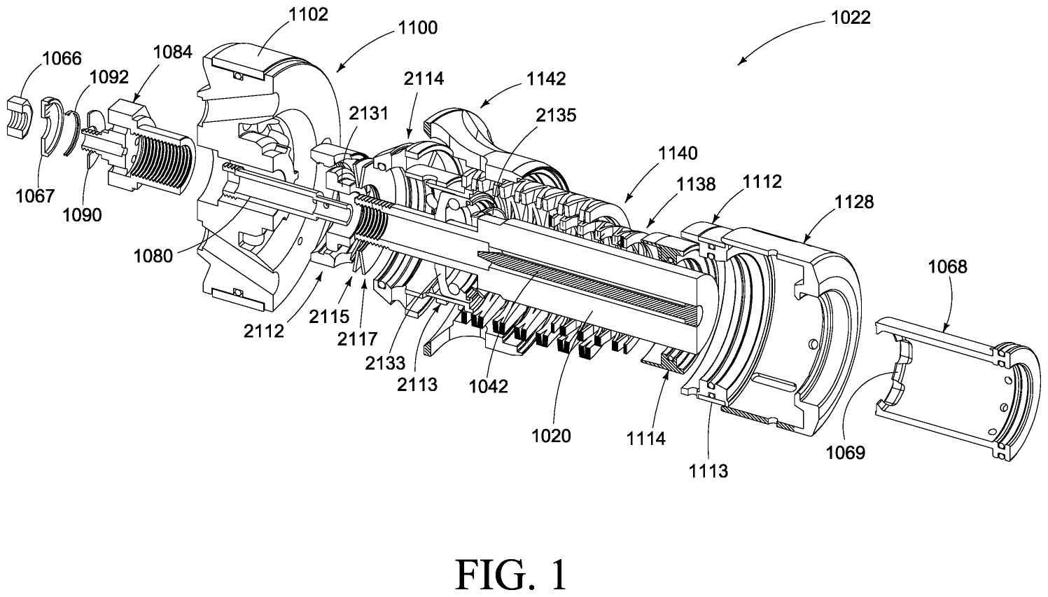

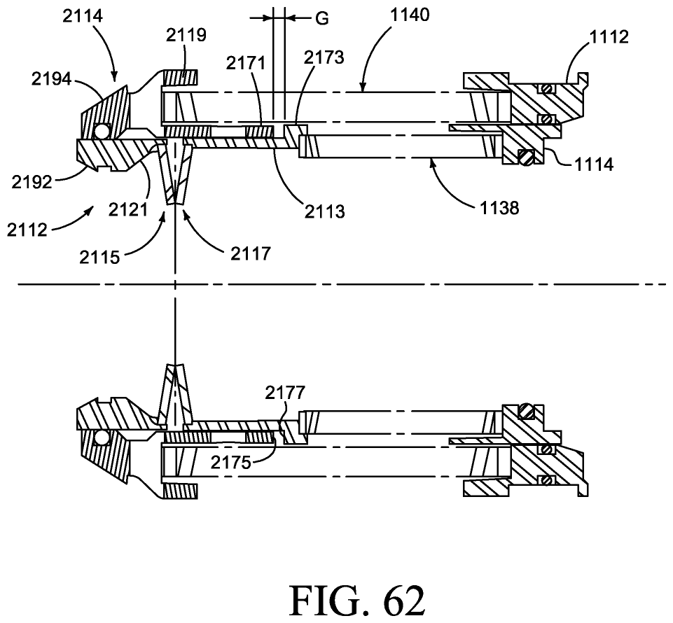

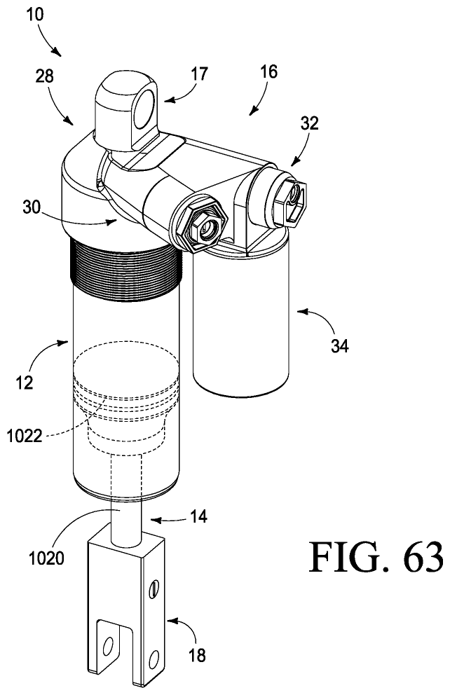

FIG. 1 is an exploded and perspective vertical centerline sectional view of a mid-valve piston assembly 1022 from the inlet end of a shock absorber assembly similar to that shown in FIGS. 62-80 in U.S. Pat. No. 11,448,282, herein incorporated by reference in its entirety. However, certain components of mid-valve piston assembly 1022 are changed over those shown in FIGS. 62-80 of U.S. Pat. No. 11,448,282. Namely, circumferential outer valving element, or outer circumferential cone piston 2114 and inner circumferential compound (or frustoconical) valving element, or inner circumferential compound cone piston 2112 cooperate to provide a modification over that shown in FIGS. 62-80 of U.S. Pat. No. 11,448,282. Specifically, inner circumferential compound cone piston 2112 forms a distal end portion that cooperates with a proximal end portion, or base flange tube 2113 and a medial spring stack of cup washers 2115 and 2117 interposed between the distal end portion 2112 and the proximal end portion 2113. An inner spring stack 1138 engages with a proximal radial inward flange end of base flange tube 2113 to urge base flange tube 2113 at a distal end with stacked cup washers 2115 and 2117 which further engage with a proximal end of inner cone piston 2112. Inner cone piston 2112 and outer cone piston 2114 move away from a circumferential valve seat on piston 1100 responsive to hydraulic fluid pressure passing through a mid-valve shock absorber piston 1100 of a shock absorber 10 (see FIG. 63). Springs 2115, 2117 and 1138 serve to urge inner cone piston 2112 via base flange tube 2113 into engagement with a circumferential valve seat on piston 1100. Hydraulic fluid pressure from a distal side of piston 1100 can urge inner cone piston 2112 away from piston 1100 to open up a circumferential inner fluid flow path, while outer cone piston 2114 can be urged away from piston 1100 to compress outer spring stack 1140 and open up a circumferential outer fluid flow path with a circumferential valve seat of piston 1100. A ducted support housing 1142 stacks and seats with piston 1100. Inner spring stack 1138 and outer spring stack 1140 are supported circumferentially about piston rod, or shaft 1020. A piston band seal 1102 (and an o-ring seal) are provided about an outer periphery of piston 1100 to form a sliding seal within an inner cylindrical wall of a shock absorber tube.

A female rebound tube 1080 is threaded within a female bore of shaft 1020, as shown in FIG. 1. A rebound nut assembly then threads atop a male thread on shaft 1020. A nut 1066 affixes a stop plate 1067, a spring 1092 and a check valve washer 1090 onto and against rebound nut assembly 1084. A threaded rebound needle 1042 is threaded coaxially within shaft 102 for axial adjustable positioning. A shaft spacer 2131 and a base cup 2133 are each made from heat treated steel. A circumferential o-ring retainer 2135 of anodized aluminum is configured to prevent an associated o-ring from being sucked, or pulled onto shaft 1020. An outer pump piston 1112 is slidably received in a cylindrical housing 1128 to act against spring 1140 responsive to rebound hydraulic fluid within a shock absorber. Likewise, an inner pump piston 1114 is slidably received within cylindrical housing 1128 to slide along shaft 1020 to act against spring 1138 responsive to rebound hydraulic fluid within a shock absorber. Pump piston 1112 includes a circumferential piston band seal 1113 (and o-ring seal). A collar 1068 having a radially inwardly extending array of fingers 1069 entraps collar 1068 on shaft 1020 such that nut 1084 entraps all associated components of mid-valve piston assembly 1022 in assembly between nut 1084 and collar 1068.

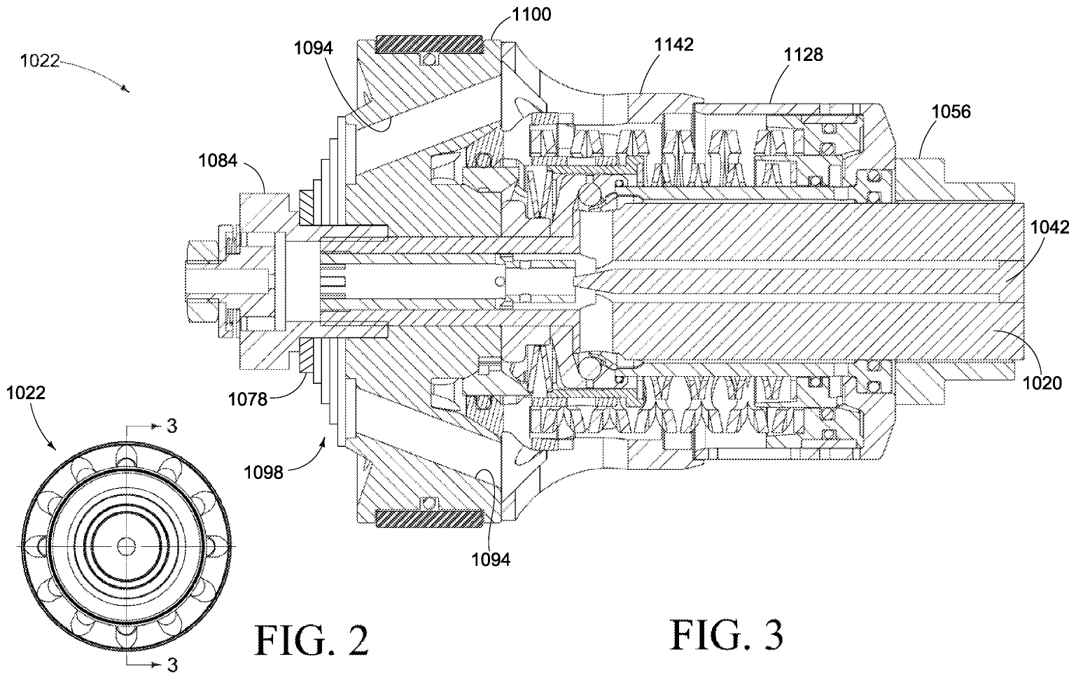

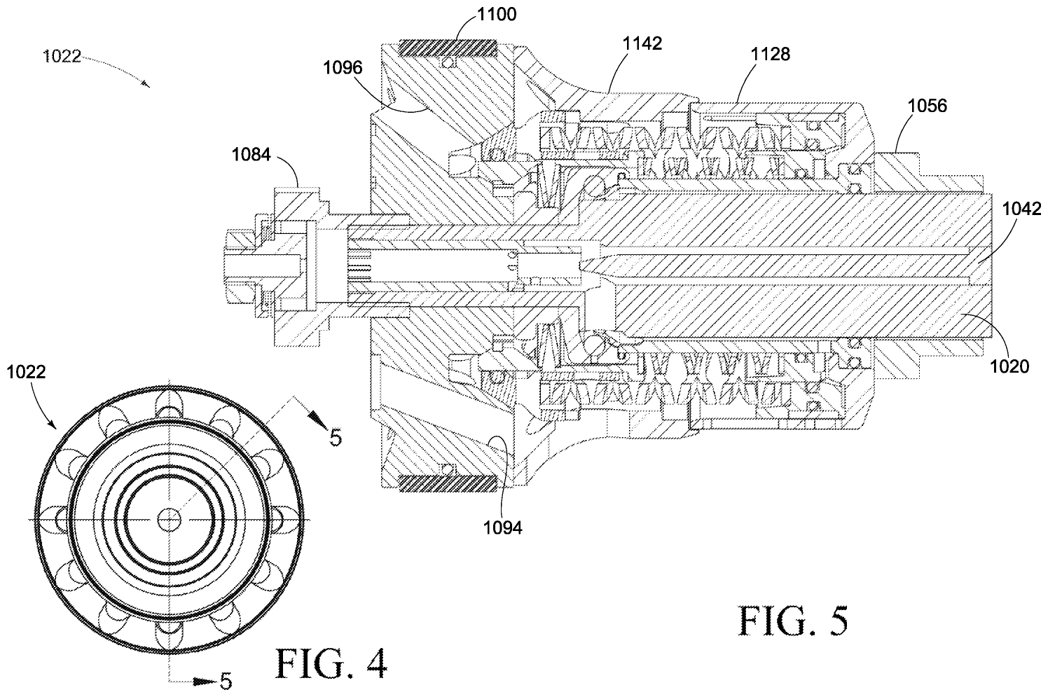

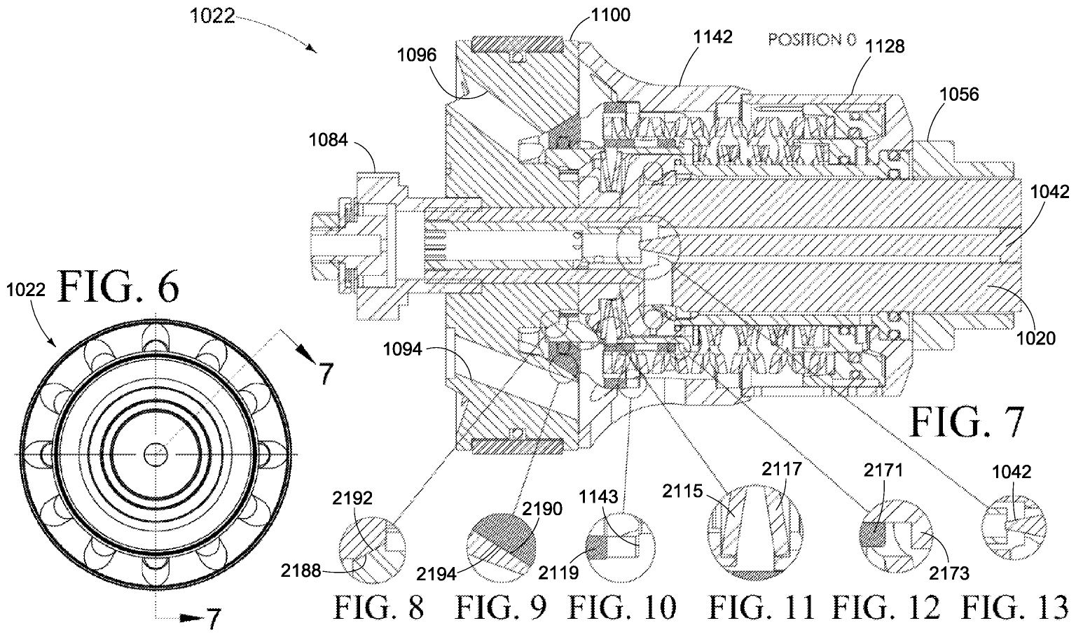

FIG. 3 is a vertical centerline sectional view of the mid-valve piston assembly 1022 taken along line 3-3 of FIG. 2 showing one pair of rebound ports 1094. A rebound shim stack assembly 1098 of individual spring steel shims are urged against piston 1100 to cover rebound ports 1094 by a spacer ring 1078 and rebound nut assembly 1084. Assembly 1098 in operation flexes to allow fluid to rebound through rebound ports 1094 back to the compression chamber of a shock absorber. Cylindrical housing 1128 is affixed on shaft 1020 to engage support housing 1142 against piston 1100 in assembly. A rubber or plastic cylindrical bump stop 1056 is provided on shaft 1020 typically spaced from housing 1128. A threaded rebound needle 1042 is threaded to axially position within shaft 1020 to control fluid flow. Shaft 1020 is shown in simplified form with a right end shown in shortened form, but would be longer in actual applications and could be shown in breakaway to indicate a longer shaft 1020 as shown in FIG. 63.

FIG. 5 is a compound sectional view of the mid-valve piston assembly 1022 taking along line 5-5 of FIG. 4 showing both a compression port 1096 and a rebound port 1094 in piston 1100. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 7 is a compound sectional view of the mid-valve piston 1022 of FIGS. 1-3 taken along line 7-7 of FIG. 6 showing both a compression port 1096 and the mid-valve piston 1100 at a static state and a rebound port 1094 at a static state showing a rebound needle 1042 (within shaft 1020) with a position adjustment change from that of FIG. 55 depicting the needle 1042 in a more open position than that of FIG. 55. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 8 is an enlarged sectional view of a mated inner valve seat 2188 and a piston surface 2192 taken from encircled region 8 of FIG. 7. More particularly, inner circumferential valve seat 2188 is shown with circumferential piston, or valving element 2192 sprung into a closed position against seat 2188 restricting any shock absorber fluid flow therebetween.

FIG. 9 is an enlarged sectional view of a mated outer circumferential valve seat 2190 and piston surface 2194 taken from encircled region 9 of FIG. 7. More particularly, outer circumferential valve seat 2190 is shown with circumferential piston, or valving element 2194 sprung into a closed position against seat 2190 restricting any shock absorber fluid flow therebetween.

FIG. 10 is an enlarged sectional view of an outer valving element outer end stop rim flange 2119 and circumferential shelf 1143 taken from encircled region 10 of FIG. 7. A gap is provided between flange 2119 and stop 1143 corresponding with the closed position of the outer circumferential valving element.

FIG. 11 is an enlarged sectional view of opposed conical springs, or Belleville washers 2115 and 2117 taken from encircled region 11 of FIG. 7 showing springs 2115 and 2117 sprung apart.

FIG. 12 is an enlarged sectional view of an outer valving element inner end stop rim flange 2171 and a circumferential shelf 2173 taken from encircled region 12 of FIG. 7 corresponding with the closed position of the outer circumferential valving element.

FIG. 13 is an enlarged sectional view of an open position for rebound needle 1042 taken from encircled region 13 of FIG. 7.

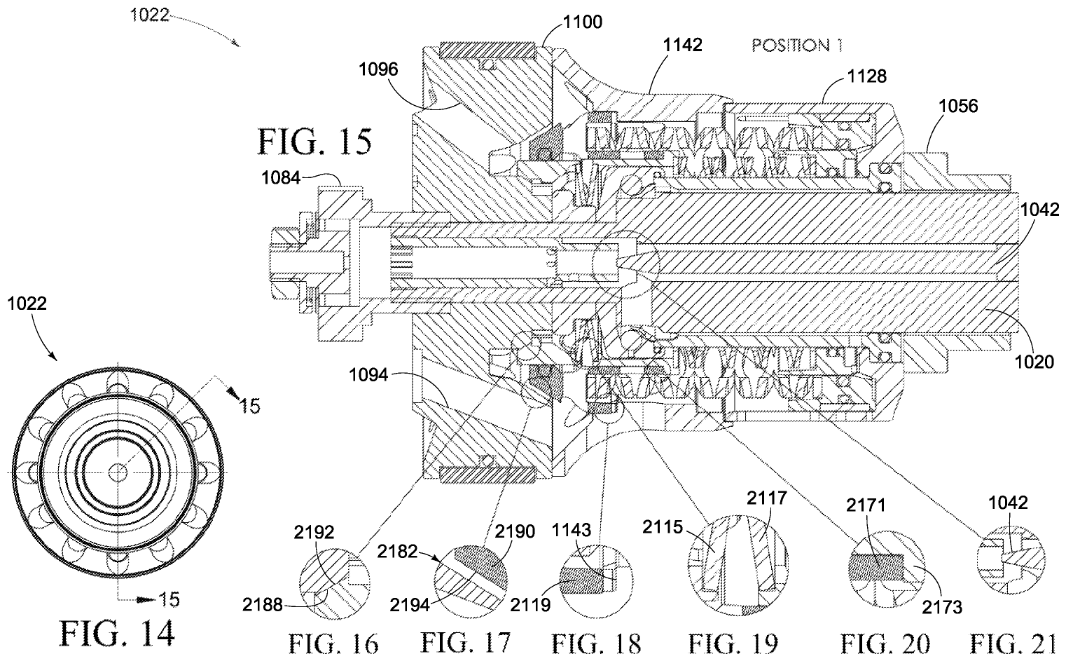

FIG. 15 is a compound sectional view of the mid-valve piston assembly 1022 of FIGS. 1-13 taken along line 15-15 of FIG. 14 showing both a compression port 1964 and a rebound port 1094 at a later state than shown in FIG. 7 with more fluid flow at a later point in time. Rebound needle 1042 (within shaft 1020) is shown with a position adjustment change from that of FIG. 55 depicting the needle 1042 in a more open position than that of FIG. 55. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 16 is an enlarged sectional view of a mated inner valve seat 2188 and a piston surface 2192 taken from encircled region 16 of FIG. 15. More particularly, inner circumferential valve seat 2188 is shown with circumferential piston, or valving element 2192 sprung into a closed position against seat 2188 restricting any shock absorber fluid flow therebetween.

FIG. 17 is an enlarged sectional view of a mated outer circumferential valve seat 2190 and piston surface 2194 taken from encircled region 17 of FIG. 15. More particularly, outer circumferential valve seat 2190 is shown with circumferential piston, or valving element 2194 urged (against spring forces) into a partially open position against seat 2190 providing a circumferential pathway 2182 for shock absorber fluid flow therebetween.

FIG. 18 is an enlarged sectional view of an outer valving element outer end stop rim flange 2119 and circumferential shelf 1143 taken from encircled region 18 of FIG. 15. A reduced size gap is provided between flange 2119 and stop 1143 corresponding with the partially open position of the outer circumferential valving element.

FIG. 19 is an enlarged sectional view of opposed conical springs, or Belleville washers 2115 and 2117 taken from encircled region 19 of FIG. 15 showing springs 2115 and 2117 sprung apart.

FIG. 20 is an enlarged sectional view of an outer valving element inner end stop rim flange 2171 and a circumferential shelf 2173 taken from encircled region 20 of FIG. 15 corresponding with the partially open position of the outer circumferential valving element with flange 2171 bottomed out, or engaged with shelf 2173.

FIG. 21 is an enlarged sectional view of an open position for rebound needle 1042 taken from encircled region 21 of FIG. 15.

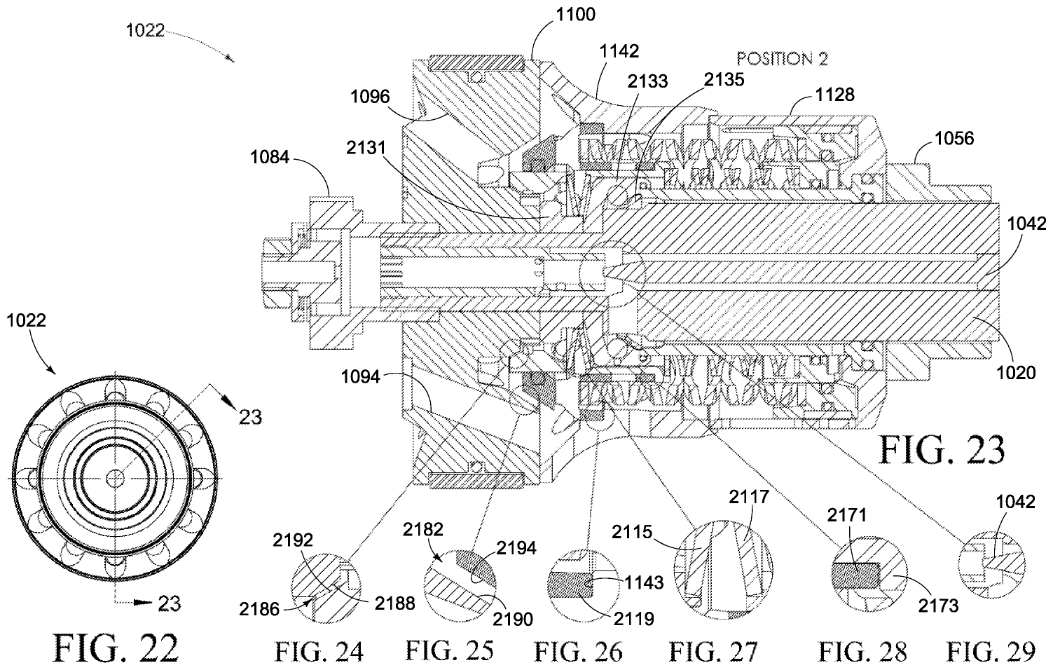

FIG. 23 is a compound sectional view of the mid-valve piston assembly 1022 of FIGS. 1-21 taken along line 23-23 of FIG. 22 showing both a compression port 1096 and a rebound port 1094 at a later state than shown in FIG. 15 with yet even more fluid flow and the initiation of pump piston movement to initiate shutting of the outer conical piston. Rebound needle 1042 (within shaft 1020) is shown with a position adjustment change from that of FIG. 55 depicting the needle 1042 in a more open position than that of FIG. 55. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 24 is an enlarged sectional view of an open and demated inner valve seat 2188 and a piston surface 2192 taken from encircled region 24 of FIG. 23 forming a circumferential fluid flow path 2186. More particularly, inner circumferential valve seat 2188 is shown with circumferential piston, or valving element 2192 urged against spring forces into an open position relative to seat 2188 providing a fluid flow pathway 2186 for shock absorber fluid flow therebetween.

FIG. 25 is an enlarged sectional view of a demated outer circumferential valve seat 2190 and piston surface 2194 taken from encircled region 25 of FIG. 23 providing a further enlarged circumferential fluid flow pathway 2182 over that shown in FIG. 17. More particularly, outer circumferential valve seat 2190 is shown with circumferential piston, or valving element 2194 urged (against spring forces) into a further open position against seat 2190 providing a circumferential pathway 2182 for shock absorber fluid flow therebetween.

FIG. 26 is an enlarged sectional view of an outer valving element outer end stop rim flange 2119 and circumferential shelf 1143 taken from encircled region 26 of FIG. 23. A completely closed gap is provided between flange 2119 and stop 1143 corresponding with the further open position of the outer circumferential valving element.

FIG. 27 is an enlarged sectional view of opposed conical springs, or Belleville washers 2115 and 2117 taken from encircled region 27 of FIG. 23 showing springs 2115 and 2117 sprung apart.

FIG. 28 is an enlarged sectional view of an outer valving element inner end stop rim flange 2171 and a circumferential shelf 2173 taken from encircled region 28 of FIG. 23 corresponding with the further open position of the outer circumferential valving element with flange 2171 bottomed out, or engaged with shelf 2173.

FIG. 29 is an enlarged sectional view of an open position for rebound needle 1042 taken from encircled region 29 of FIG. 23.

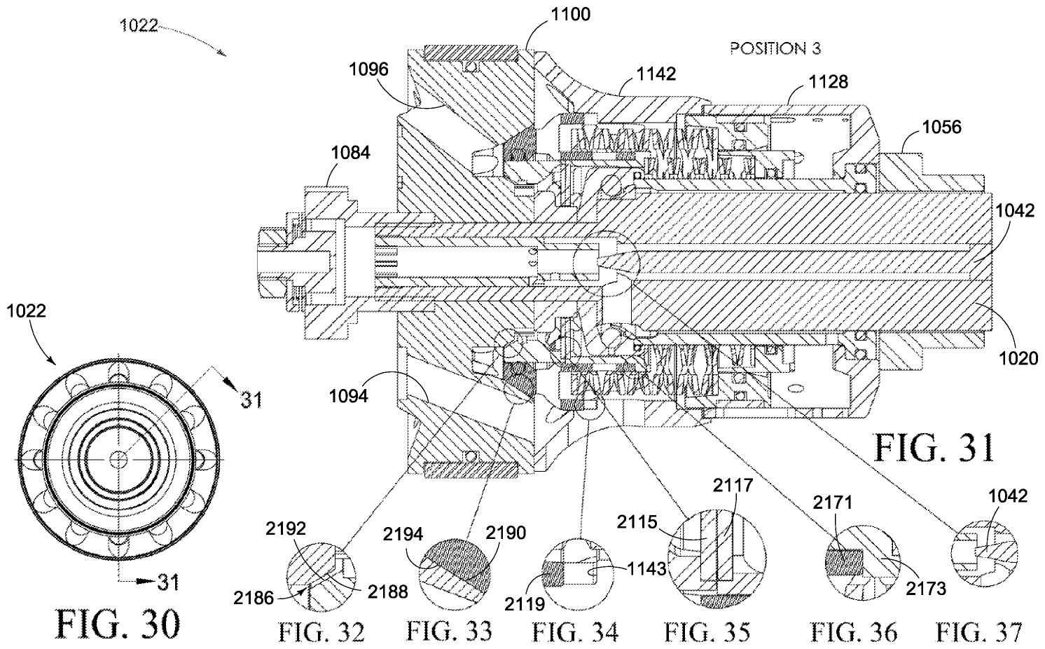

FIG. 31 is a compound sectional view of the mid-valve piston assembly 1022 of FIGS. 1-29 taken along line 31-31 of FIG. 30 showing both a compression port 1096 and a rebound port 1094 at a later state than shown in FIG. 23 with fluid flow restriction where the outer conical piston is closed. Rebound needle 1042 (within shaft 1020) is shown with a position adjustment change from that of FIG. 55 depicting the needle 1042 in a more open position than that of FIG. 55. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 32 is an enlarged sectional view of an open and demated inner valve seat 2188 and a piston surface 2192 taken from encircled region 32 of FIG. 31 forming a circumferential fluid flow path 2186. More particularly, inner circumferential valve seat 2188 is shown with circumferential piston, or valving element 2192 urged against spring forces into an open position relative to seat 2188 providing a fluid flow pathway 2186 for shock absorber fluid flow therebetween.

FIG. 33 is an enlarged sectional view of a closed, or mated outer circumferential valve seat 2190 and piston surface 2194 taken from encircled region 33 of FIG. 31 providing a no circumferential fluid flow pathway 2182 over that shown in FIG. 17. More particularly, outer circumferential valve seat 2190 is shown with circumferential piston, or valving element 2194 urged (against spring forces) into a closed, or mated position against seat 2190 providing a closed circumferential pathway 2182 for shock absorber with no fluid flow therebetween.

FIG. 34 is an enlarged sectional view of an outer valving element outer end stop rim flange 2119 and circumferential shelf 1143 taken from encircled region 34 of FIG. 31. A completely open gap is provided between flange 2119 and stop 1143 corresponding with the open position of the outer circumferential valving element.

FIG. 35 is an enlarged sectional view of opposed conical springs, or Belleville washers 2115 and 2117 taken from encircled region 35 of FIG. 31 showing springs 2115 and 2117 urged together into a completely closed, or stacked position.

FIG. 36 is an enlarged sectional view of an outer valving element inner end stop rim flange 2171 and a circumferential shelf 2173 taken from encircled region 36 of FIG. 31 corresponding with the open position of the outer circumferential valving element with flange 2171 bottomed out, or engaged with shelf 2173.

FIG. 37 is an enlarged sectional view of an open position for rebound needle 1042 taken from encircled region 37 of FIG. 31.

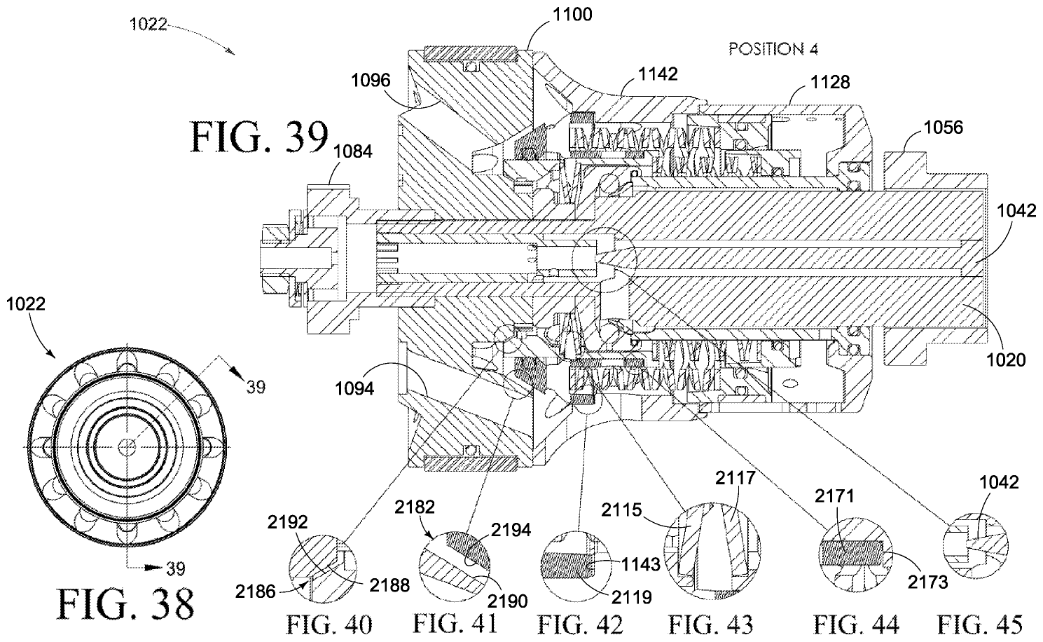

FIG. 39 is a compound sectional view of the mid-valve piston assembly 1022 of FIGS. 1-37 taken along line 39-39 of FIG. 38 showing both a compression port 1096 and a rebound port 1094 at a later state than shown in FIG. 31 with fluid flow restriction allowing bypass where the outer conical piston body is opening again in response to a threshold excessive force. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 40 is an enlarged sectional view of an open and demated inner valve seat 2188 and a piston surface 2192 taken from encircled region 40 of FIG. 39 forming a circumferential fluid flow path 2186. More particularly, inner circumferential valve seat 2188 is shown with circumferential piston, or valving element 2192 urged against spring forces into an open position relative to seat 2188 providing a fluid flow pathway 2186 for shock absorber fluid flow therebetween.

FIG. 41 is an enlarged sectional view of an open, or demated outer circumferential valve seat 2190 and piston surface 2194 taken from encircled region 41 of FIG. 39 providing a demated circumferential fluid flow pathway 2182. More particularly, outer circumferential valve seat 2190 is shown with circumferential piston, or valving element 2194 urged (against spring forces) into an open position relative to seat 2190 providing a circumferential pathway 2182 for shock absorber fluid flow therebetween.

FIG. 42 is an enlarged sectional view of an outer valving element outer end stop rim flange 2119 and circumferential shelf 1143 taken from encircled region 42 of FIG. 39. A completely closed gap is provided between flange 2119 and stop 1143 as they are in contact, corresponding with the open position of the outer circumferential valving element.

FIG. 43 is an enlarged sectional view of opposed conical springs, or Belleville washers 2115 and 2117 taken from encircled region 43 of FIG. 39 showing springs 2115 and 2117 spaced apart in a completely open or uncompressed position.

FIG. 44 is an enlarged sectional view of an outer valving element inner end stop rim flange 2171 and a circumferential shelf 2173 taken from encircled region 44 of FIG. 39 corresponding with the open position of the outer circumferential valving element with flange 2171 bottomed out, or engaged with shelf 2173.

FIG. 45 is an enlarged sectional view of an open position for rebound needle 1042 taken from encircled region 45 of FIG. 39.

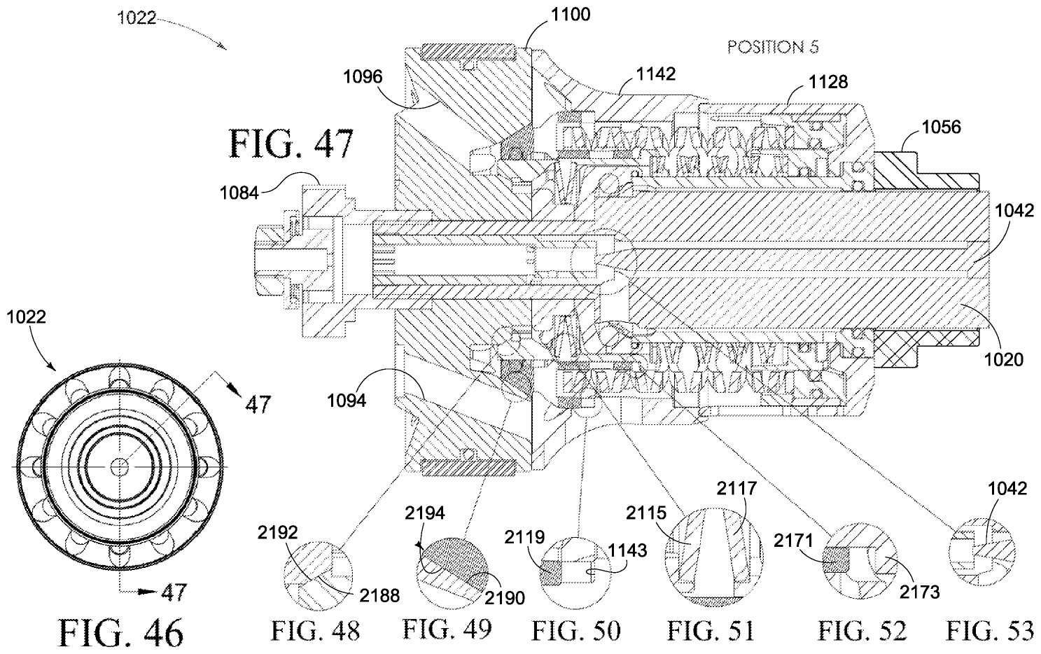

FIG. 47 is a compound sectional view of the mid-valve piston assembly of FIGS. 1-45 taken along line 47-47 of FIG. 46 showing both a compression port 1096 and a rebound port 1094 at a later state than shown in FIG. 39 with a perspective in a rebound fluid flow direction causing the rebound flapper valve stack (not shown) to move to an open flow position in response to a rebound stroke. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 48 is an enlarged sectional view of a closed, or mated inner valve seat 2188 and a piston surface 2192 taken from encircled region 48 of FIG. 47 forming a closed circumferential fluid flow path 2186 (see FIG. 40). More particularly, inner circumferential valve seat 2188 is shown with circumferential piston, or valving element 2192 urged by spring forces into engagement with seat 2188 and providing no fluid flow pathway for shock absorber fluid flow therebetween.

FIG. 49 is an enlarged sectional view of a closed, or mated outer circumferential valve seat 2190 and piston surface 2194 taken from encircled region 49 of FIG. 47 providing a closed, or mated circumferential fluid flow pathway. More particularly, outer circumferential valve seat 2190 is shown with circumferential piston, or valving element 2194 urged into contact with seat 2190 providing no circumferential pathway for shock absorber fluid flow therebetween.

FIG. 50 is an enlarged sectional view of an outer valving element outer end stop rim flange 2119 and circumferential shelf 1143 taken from encircled region 50 of FIG. 47. A completely open gap is provided between flange 2119 and stop 1143 as they are spaced apart, corresponding with the closed position of the outer circumferential valving element.

FIG. 51 is an enlarged sectional view of opposed conical springs, or Belleville washers 2115 and 2117 taken from encircled region 51 of FIG. 47 showing springs 2115 and 2117 spaced apart in a completely open or uncompressed position.

FIG. 52 is an enlarged sectional view of an outer valving element inner end stop rim flange 2171 and a circumferential shelf 2173 taken from encircled region 52 of FIG. 47 corresponding with the closed position of the outer circumferential valving element with flange 2171 spaced apart from shelf 2173.

FIG. 53 is an enlarged sectional view of an open position for rebound needle 1042 taken from encircled region 53 of FIG. 47.

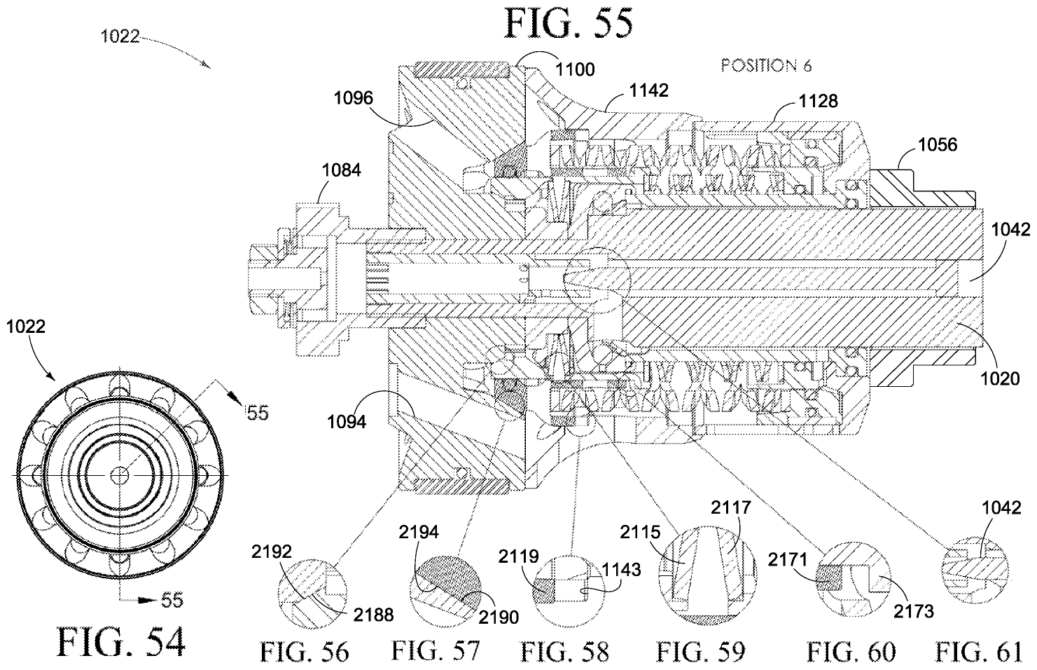

FIG. 55 is a compound sectional view of the mid-valve piston assembly 1022 of FIGS. 1-53 taken along line 55-55 of FIG. 54 showing both a compression port 1096 and the mid-valve piston 1100 at a static state and a rebound port 1094 at a static state showing a rebound needle 1042 of within shaft 1020 in a position adjustment changed from that of FIG. 47 depicting the needle 1042 positioned in a more, or nearly closed position than that of FIG. 47 and a rebound port 1094 at a later state than shown in FIG. 47 with fluid flow restriction allowing bypass where the outer conical piston is opening again in response to a threshold excessive force. The shim stack assembly 1098 of FIG. 3 has been omitted to simplify the view. Bump stop 1056, housing 1128, support housing 1142, nut 1084, shaft 1020 and rebound needle 1042 are as shown and described in FIG. 3.

FIG. 56 is an enlarged sectional view of a closed, or mated inner valve seat 2188 and a piston surface 2192 taken from encircled region 56 of FIG. 55 forming a closed circumferential fluid flow path 2186 (see FIG. 40). More particularly, inner circumferential valve seat 2188 is shown with circumferential piston, or valving element 2192 urged by spring forces into engagement with seat 2188 and providing no fluid flow pathway for shock absorber fluid flow therebetween.

FIG. 57 is an enlarged sectional view of a closed, or mated outer circumferential valve seat 2190 and piston surface 2194 taken from encircled region 57 of FIG. 55 providing a closed, or mated circumferential fluid flow pathway. More particularly, outer circumferential valve seat 2190 is shown with circumferential piston, or valving element 2194 urged into contact with seat 2190 providing no circumferential pathway for shock absorber fluid flow therebetween.

FIG. 58 is an enlarged sectional view of an outer valving element outer end stop rim flange 2119 and circumferential shelf 1143 taken from encircled region 58 of FIG. 55. A completely open gap is provided between flange 2119 and stop 1143 as they are spaced apart, corresponding with the closed position of the outer circumferential valving element.

FIG. 59 is an enlarged sectional view of opposed conical springs, or Belleville washers 2115 and 2117 taken from encircled region 59 of FIG. 55 showing springs 2115 and 2117 spaced apart in a completely open or uncompressed position.

FIG. 60 is an enlarged sectional view of an outer valving element inner end stop rim flange 2171 and a circumferential shelf 2173 taken from encircled region 60 of FIG. 55 corresponding with the closed position of the outer circumferential valving element with flange 2171 spaced apart from shelf 2173.

FIG. 61 is an enlarged sectional view of an open position for rebound needle 1042 taken from encircled region 61 of FIG. 55.

FIG. 62 is a simplified partial component view showing the circumferential outer valving element, or outer circumferential cone piston 2114 and the inner circumferential compound valving element, or inner circumferential compound cone piston 2112. Cone piston 2112 forms a distal end component of a compressible two component member having an intermediate spring. More particularly, a pair of cone washers, or springs 2115 and 2117 are stacked between distal cone piston tube 2121 and proximal base flange tube 2113 to form cone piston 2112. Base flange tube 2113 has a radially outwardly extending proximal flange 2173 that engages on a proximal side with spring stack 1138 and on a distal side with a proximal end of outer cone piston 1114, save for a gap, “G” that delays engagement as outer cone piston 2114 is moved to an open position in a proximal direction away from the mid-valve piston (not shown). Outer valving element outer end stop rim flange 2119 also acts as a motion stop, as discussed previously above. Flange 2173 can engage with flange 2171 of outer circumferential compound cone piston 2114 along circumferential surfaces 2175 and 2177 which causes both springs 1138 and 1140 to act on piston 2114 to urge it closed when gap “G” is closed. Outer pump piston 1112 and inner pump piston 1114 receive pressure from hydraulic fluid in a rebound chamber to further urge springs 1138 and 1140 into outer cone piston 2114 and inner cone piston 2112, respectively. Under lower hydraulic pressure through the mid-valve piston, outer spring stack 1140 engages outer cone piston 2114 along circumferential piston surface 2194 with an outer circumferential valve seat 2190 on the mid-valve piston 1100 (see FIG. 7). Inner spring stack 1138 engages inner cone piston 2112 along circumferential piston surface 2192 with inner circumferential valve seat 2188 on mid-valve piston 1100 (see FIG. 7). Inner cone piston 2112 and outer cone piston 2114 each form a valving element.

FIG. 62 is a simplified partial component view showing the circumferential outer valving element which is explained in greater detail above with reference to FIG. 31 in a compressing and closing state wherein one version provides that elements are compounded to allow for spring and action from one direction of valve seat demating and from another aspect to mate and provide compound spring activity when closing. A first part of FIG. 62 is from a demate perspective articulation. Now from a compound mating spring compression aspect, an outer circumferential cone piston 2114 is supported by spring pressure created via slidable piston 1112 moving towards the spring 1140 and compressing the outer elements to seat more firmly with a more robust force of the spring 1140 imparting tension with compressing action of the outer spring creating a tighter seat pressure against the primary mid-valve piston 1100 valve element (not shown). See FIG. 31. Outer piston valve element 1112 independently slides coaxially over inner piston valve element shown in FIG. 31 as well as with inner valving piston element separately working to allow for individual acting leverages due to leverage ratios of larger diameter leverage force of piston element 1112 and lesser leverage by a lesser leverage area volume size of inner piston element 1114. According to one construction, a unique spring deign 1140 is a wave spring which is developed to work similarly with rates or has the ability to overcome the standard rate challenge of larger diameter springs using more wire as a smaller diameter spring. A wave spring 1138 and 1140 has many waves on each coil constructed between coils to make rates to a needed value that will not be affected by a diameter size of the spring. As outer circumferential valving element has a larger sealing edge, it also will take advantage of a compounding spring rate from springs 1138 and 1140 when they work together during the ratio of combined pumping piston action from the chamber being filled with fluid to expand the chamber cylinder and press on the spring 1138 and 1140. As stated previously. pistons 1114 and 1112 cooperate with elements of the chamber volume and work with leverage proportion, the springs 1138 and 1140 and the inner and outer sprung circumferential valving elements 2114 and 2112 work independently to close or compress the circumferential valve seats 2112 and 2114 against the piston 1100 to close off or stiffen fluid travel through the piston compression ports 1094 and annular piston chamber 1116 during a compression stroke of the shock absorber. With the momentum and the power of the spring 1138 and 1140, tension increases and the springs compress the cup washers, or cone springs 2115 and 2117 at a rate wherein the gap “G” will lessen and eventually the base flange tube will engage against the outer circumferential piston 2114. Along an end opposite the seat end and with connection, the inner circumferential valving element 2112 and the outer circumferential valving element 2114 both will have existing tension of spring force from individual spring elements 1138 and 1140. After the base flange tube connects, closing the gap, “G” both springs 1138 and 1140 become united and work together to extend/increase/power up spring work force power to favor/direct/add to the outer circumferential valving element 2114. This will modify the sprung force of one/each spring rate to combine the springs 1138 and 1140 during the compressing/shortening of springs 2115 and 2117. This will impart increased spring rate to close both circumferential valving elements 2114 and 2112 more forcibly with only extra/more/connected (double sprung) power only being directed to the outer circumferential valving element 2114. Inner circumferential valving element 2112 will retain only the rates of inner spring 1138 and cone washers 2115 and 2117 even under full compression of the two other springs 1138 and 1140. Importantly until the gap “G” is completely used up, outer seat 2114 has the ability to act with only the outer spring 1140 up until it opens far enough to close gap “G” and is stiffened. The pumping action can also eat up the gap “G” and dual the ratio to the “outer” circumferential seat 2114. Gap “G” works in both directions. All of the springs can be tuned to a desired ratio.

FIG. 63 is a perspective view from above of an exemplary hydraulic shock absorber 10 having a primary mid-valve piston assembly 1022 of FIGS. 1-62 and a secondary pair of adjustable auxiliary hydraulic fluid valves 30 and 32. Shock absorber 10 includes a main cylindrical shock tube, or cylinder 12 containing a primary mid-valve piston 1022 carried for movement within an internal cylindrical bore between a compression chamber and a rebound chamber within tube 12. Tube 12 has an end cap 28 that forms an adjuster and reservoir end cap assembly 16 that includes and supports secondary pair of primary and secondary adjustable auxiliary hydraulic fluid valves 30 and 32 within bridge end cap, or body 28. Although not shown, a dust cap and a seal head assembly are provided along a bottom end of cylinder 12 and provide support for shaft 1020 during reciprocation relative to cylinder 12. Each fluid valve 30 and 32 communicates in fluid relation with a piston and reservoir assembly 34. Shock absorber assembly 10 is installed between articulating components of a suspension or shock absorbing mechanism, such as a vehicle suspension, using a busing and bolt (not shown) through a top-most bushing 17 and a bolt and busing (not shown) that extends through bottom-most clevis 18. Clevis 18 is affixed to a bottom end of a reciprocating piston rod assembly 14 including shaft, or rod 1020. Other alternative mounting configurations, constructions and orientations are also possible for shock 10.

Operating components of the primary structural elements depicted in FIGS. 1-63 can be constructed from aluminum, anodized aluminum, steel and hardened steel. Other suitable materials can include composite materials and plastics or rubbers.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A shock absorber, comprising:
a cylinder filled with a fluid;
a piston rod reciprocating within the cylinder;
a piston body;
a valve carried by the piston body having:
at least one flow port through the piston body and communicating with a compression chamber end of the valve body;
a first valve seat formed at least in part by the piston body;
a second valve seat formed at least in part by the piston body;
an annular valve chamber defined in part by the piston body and fluid coupled with the at least one flow port;
a first circumferential valving element configured to mate and demate with the first valve seat at a proximal end and having a radially inward extending engagement flange on a proximal end;
a second circumferential valving element having a distal end portion, a proximal end portion, and a medial spring interposed between the distal end portion and the proximal end portion, the distal end portion configured to mate and demate with the second valve seat and engage with the proximal end of the first circumferential valving element when the first valving element demates with the first valve seat and the second valve element is mated with the second valve seat;
a first valve spring configured to urge the first valving element in movable mating and demating relation against the first valve seat;
a second valve spring configured to urge the second valving element in movable mating and demating relation against the second valve seat, the first valve seat and the second valve seat each respectively demated from the first valve seat and the second valve seat responsive to fluid pressure in the annular valve chamber compressing the first spring and the second spring to provide a first fluid flow path and a second fluid flow path; and
a housing including an auxiliary reservoir communicating with one of the compression chamber and the rebound chamber and a by-pass passage penetrating an inside of the piston rod in a longitudinal direction of the piston rod, the housing configured to form an auxiliary passage connected to one of the compression chamber and the rebound chamber.

2. The shock absorber of claim 1, further comprising a first pump piston and a second pump piston each received within a chamber of a pump piston housing constructed and arranged to receive fluid in communication with the auxiliary reservoir.

3. The shock absorber of claim 1, wherein the first circumferential valving element is a first cylindrical piston having an outer frustoconical piston surface and the second circumferential valving element is a second cylindrical piston nested coaxially within the first cylindrical piston and having an inner frustoconical piston surface.

4. The shock absorber of claim 3, wherein the first valve seat is a frustoconical outer valve seat and the second valve seat is an inner frustoconical inner valve seat provided coaxially within the first frustoconical valve seat.

5. The shock absorber of claim 4, wherein the outer frustoconical piston surface is constructed and arranged to mate and demate with the outer frustoconical valve seat and the inner frustoconical piston surface is constructed and arrange to mate and demate with the inner frustoconical valve seat.
